(19) United States
(12) Patent Application Publication
(10) Pub. No.: US 2005/0129125 A1
(43) Pub. Date: Jun. 16, 2005

(54) Method and apparatus for pitcure compression using variable block of arbitrary size

(75) Inventors: Sang-chang Cha, Hwaseong-si (KR); Jong-hak Ahn, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/986,040

(22) Filed: Nov. 12, 2004

(30) Foreign Application Priority Data
Nov. 17, 2003 (KR) 10-2003-0081192

(51) Int. Cl. H04N 7/12

(52) U.S. Cl. 375/240.16; 375/240.24

(57) ABSTRACT

Disclosed is a method and apparatus for picture compression using a variable block of an arbitrary size, the method comprising: a first step of calculating motion vectors of desired variable blocks; a second step of dividing a screen into a plurality of blocks of arbitrary sizes according to the calculated motion vectors of the variable blocks; and a third step of determining motion vectors with respect to each of the plurality of blocks of the arbitrary sizes constructing the divided screen. Also, the method comprises a first step of compensating motion with respect to blocks of arbitrary sizes from which the motion vectors are decided; and a second step of transmitting block information of an arbitrary size for which the motion is compensated, in order, from a block disposed on the upper left of the screen to a block disposed on the lower right of the screen.

This application claims priority of Korean Patent Application No. 10-2003-0081192 filed on Nov. 17, 2003 in the Korean Intellectual Property Office, the disclosure of which is incorporated herein in its entirety by reference.

### BACKGROUND OF THE INVENTION

1. Field of the Invention

The present invention relates to a method and apparatus for picture compression and, more particularly, for picture compression using a variable block of an arbitrary size.

2. Description of the Related Art

Removing data redundancy is a basic principle of data compression. Data can be compressed by removing spatial redundancy such as the repetition of the same color or object in an image; temporal redundancy such as when there are a few changes between adjacent frames with the lapse of time in a motion picture frame or the continuous repetition of the same audio sound in an audio track; or physiological visual redundancy in consideration that human visual perception is not sensitive to high frequency. The data compression schemes are classified into a lossy compression scheme and a lossless compression scheme according to whether the source data suffer a loss or not, respectively; an intra-frame compression scheme and an inter-frame compression scheme according to whether each frame is compressed independently or not, respectively; and a symmetrical compression scheme and a non-symmetrical compression scheme according to whether the time needed to compress and the time needed to decompress are the same or not, respectively. Intra-frame compression scheme is used to remove spatial redundancy and inter-frame compression scheme is used to remove temporal redundancy.

Most of the current video coding standards, including MPEG-2, MPEG-4, H.263 and H.264, are based on a motion-compensated prediction-coding scheme, wherein temporal redundancy is removed by motion compensation and spatial redundancy is removed by a transformation coding. For the MPEG standards, spatial redundancy is removed by a Discrete Cosine Transform (DCT), and for the H.264 standard, spatial redundancy is removed by an Integer Transform.

To remove temporal redundancy, a motion vector is obtained by performing motion estimation, which indicates how much a constructional unit, for example a macro block, of a frame moves with respect to a corresponding macro block in a frame of the next time period. After finishing the motion estimation, temporal redundancy between frames is removed through temporal filtering by performing motion compensation. However, removing temporal redundancy requires many calculations, and many algorithms have been suggested to reduce the calculations.

Currently, the MPEG1/2/4 standards from ISO (International Organization for Standardization) and the H.261/H.263/H.26L standards from ITU (International Telecommunication Union) are widely used as international standards for motion picture compression. While the MPEG4 and H.26L standards are targeted for applications in a wireless communication environment of a low transmission rate, the MPEG in the ISO and VCEG in the ITU have commonly formed a JVT (Joint Video Team) and have drafted a motion picture compression standard of a low transmission rate in March, 2003.

The title of this standard is called H.264 in the ITU, and MPEG-4 part 10 or AVC (Advanced Video Coding) in the ISO. The H.264 standard is a motion picture compression standard suitable for a network environment and has a strengthened error resilience, which enhances its compression rate more than 50% in comparison with the H.263 version 2 (H.263 plus) and MPEG-4 Advanced Simple Profile. Also, the H.264 standard has been adopted as a standard of DMB (Digital Multimedia Broadcasting).

FIG. 1A is a block diagram showing a coding function of a H.264 motion compressing apparatus, and FIG. 1B is a block diagram showing a decoding function of a H.264 motion picture compression apparatus. The definition of “motion picture compression” as used in this description includes both encoding and decoding.

In the H.264 standard, the compression scheme with respect to time includes a variable block motion estimation scheme of a hierarchy structure. In order to optimize motion estimation, first, the optimal motion vector and its cost with respect to bit rate and distortion are calculated by performing the motion estimation with respect to a first mode. Second, the motion vector and its cost are calculated with respect to a second mode, and the calculated cost is compared with the cost calculated in the first mode so as to select the lowest cost mode. Third, the second method is repeatedly performed for all modes to make a combination of modes requiring the least cost.

Hereinafter, the role of each of the function blocks denoting an encoding function of the H.264 motion picture compression apparatus shown in FIG. 1A is briefly explained.

A motion estimation unit 10 and a motion compensating unit 12 perform an estimation of how much the picture has moved by comparing similar parts in corresponding blocks of a picture of the previous frame and a picture of the current frame. Then, the motion estimation unit 10 and the motion compensating unit 12 make a predicted picture by compensating the previous frame by the discovered movement. An intra-prediction selection unit 14 and an inter-prediction unit 16 make a prediction of the picture of a new block based on information with respect to the adjacent blocks in the current frame.

A transform unit 18 compresses a difference picture, which is the residual after subtracting the predicted picture from the original picture, into a DCT-based transform signal. In DCT, a picture signal is transformed into a frequency domain so that its distribution can be transformed into information that is visually important and information that is visually less important.

A quantizer 20 performs actual data compression by dividing the transformed signal by a predetermined step size and removing the visually less important information. Here, the higher the value of the predetermined step size, the lower the quality of the picture and the higher the compression. Even though total accuracy of a constant coefficient reduces in case of quantization, it is used to remove a high frequency coefficient.

A reordering unit 22 distributes the picture signal in two dimensions, and the signals are concentrated on the top-left of a screen in the course of the above transformation and quantization. The signals are obtained by zigzagging in a diagonal direction, and the signals become smaller as they go to the bottom-right of the screen, where the signals become 0. The signals rearranged as described above are more advantageous than an arrangement having 0s intermediately in the compression.

An entropy-encoder 24 performs lossless compression by transforming the rearranged signals in the reordering unit 22 into coefficients in a predetermined rule.

The original picture is reconstructed by a decoder receiving compressed pictures, however, the compressed pictures suffer losses due to the quantization in the encoder. A decoder receiving these pictures only has information on pictures that have been distorted in proportion to the compression ratio. An encoder removes redundant parts from a picture of the current frame based on information in the previous frame by using a motion estimation/compensation method and selecting an intra-prediction/intra-prediction method. In light of the above, results of the encoding process and the decoding process can only be the same when a previously possessed frame by the decoder is used in the encoding process. Accordingly, the inverse-quantization and inverse-transform units 26 and 28 perform the inverse-quantization/inverse-transform in order to provide the information of the previous frame, which will be used in the motion estimation unit 10 and the motion compensation unit 12.

Since pictures are divided into block units and quantized, the higher the quantization coefficient value the less continuous the picture signal in the block boundaries. Accordingly, the picture may resemble a mosaic. This phenomenon is called a blocking artifact, and the deblocking filter 30 is used to enhance the subjective quality of the picture by removing the blocking artifact.

When similar parts of the current frame are removed based on data of the previous frame, its compression efficiency can be enhanced by referring to a plurality of previous frames. Therefore, multiple reference frames 34 has a plurality of previous frames.

The performance of an encoding function of a motion picture compression apparatus of FIG. 1A will be explained based on the role of each functional unit.

An input frame Fₙ to be encoded is inputted as a macro block unit having 16×16 pixels. Each macro block is encoded as intra-mode and as inter-mode. A prediction macro block P is formed based on a reconstructed frame, wherein, in intra-mode, P is formed from samples of a current frame n, and, in inter-mode, P is formed by a motion compensated prediction from multiple reference frames.

Referring to FIG. 1A, the reference frame, which is encoded in the previous stage, is indicated as a frame F′ₙ₋₁. However, the prediction macro block P, with respect to each macro block, may be formed from a plurality of previous frames or future frames that have already been encoded and reconstructed.

The prediction P is subtracted from the current macro block and calculates a difference macro block Dₙ. Difference macro block Dₙ is transformed by the transform unit 18, is quantized through the quantizer 20, and is then used to generate a set of quantized transform coefficients, X. Quantized transform coefficients X are reordered by the reordering unit 22 and entropy encoded by the entropy encoder 24. Entropy-transform coefficients, together with additional information required to decode the macro block (such as the motion vector, the macro block prediction mode and the quantizer step size, which indicate how the macro block was motion compensated) form a compressed bit stream. This is passed to a Network Abstraction Layer (NAL) for transmission or storage.

Referring to FIG. 1A, the quantized transform coefficients X are decoded in order to reconstruct a frame for encoding of further macro blocks. The coefficients X are dequantized and inversely transformed to produce a difference macro block D′ₙ. D′ₙ is different from the original difference macro block Dₙ because the quantization process introduces losses and so that D′ₙ is a distorted version of the original difference macro block Dₙ. Then, the prediction macro block P is added to the D′ₙ to create a reconstructed macro block uF′ₙ. A deblocking filter 30 is applied to reduce the effects of blocking distortion and a reconstructed reference frame is created from a series of macro blocks F′ₙ.

Now, a decoding function of the H.264 motion picture compression apparatus shown in FIG. 1B is explained.

A decoder receives an encoded bit stream from the NAL, wherein the data of the bit stream generates a set of quantized coefficients, X, by way of a entropy decoding unit 25 and a reordering unit 22. Then, D′ₙ is obtained by way of an inverse quantizer 26 and an inverse transform unit 28. The decoder generates a prediction macro block P using header information decoded from the bit stream. So, the prediction macro block P is added to the D′ₙ to generate uF′ₙ. Macro block, F′ₙ, is decoded from uF′ₙ by way of a deblocking filtering unit 30.

As illustrated in FIGS. 1A and 1B, the encoder and the decoder use the same reference frames in order to form prediction macro block P.

FIG. 2A is a view showing block sizes in accordance with different modes of a hierarchy structure in the H.264 standard, and FIG. 2B shows an example of an arrangement of different modes of the hierarchy structure in the H.264 standard.

Motion compensation in the H.264 standard is performed by using a variable block of the hierarchy structure shown in FIG. 2A. In motion estimation, a Sum of Absolute Difference (SAD) value is obtained for each of the 7 modes, and a motion vector is obtained from the mode having the minimum value. A mode 1 (210), a mode 2 (220) and a mode 3 (230) can be selected in a macro block unit having a 16×16 size; a mode 4 (240), mode 5 (250) and a mode 6 (260) can be selected in a macro block unit having an 8×8 size; and a mode 7 (270) can be selected in a sub-block unit having a 4×4 size.

A frame can be constructed using various modes as shown in FIG. 2B. The mode 1 (210) is selected for a background having little motion, and a higher mode is selected for a point having a lot of motion.

The cost calculation method generally used in motion estimation of the motion picture compression algorithm of the variable block size of the hierarchy structure is SAD, however, this method of calculating the optimal motion vector is very complicated. In order to perform motion estimation using the H.264 standard, SAD values with respect to all sub-blocks having a 4×4 size (mode 7) are obtained. Then, SAD values with respect to sub-blocks of 4×8, 8×4, 8×8, 16×8, 8×16 and 16×16 are obtained by adding adjacent SAD values of 4×4 size, and both SAD values are compared. This method requires many calculations which can increase time and financial cost of the motion picture coding. Furthermore, since the H.264 standard performs the searching process by interpolating the value to ¼ pixel, which is different from the previous MPEG standards, the amount of calculation needed to find the optimal motion vector increases by 4 times when compared to ½ pixel searching and by 16 times when compared to 1 pixel searching.

On the other hand, the ratio of the amount of bits to transformation coefficients is high in the case of high quality images, whereas, the relative amount of bits to motion coefficients is high in the case of low quality images. This is because the bit amount to the motion coefficients remains substantially unchanged but the amount of bits to the transformation coefficients is reduced in low quality images, in comparison with high quality images. Therefore, an effective compression technique suitable for low quality images is needed to reduce the amount of bits of the motion coefficients. For this purpose, the H.264 standard uses either only difference information of the motion coefficients of adjacent blocks or does not use information on the block size or motion coefficients by adopting a separate skip mode if the block size is 16×16, thereby reducing the bit amount of the motion coefficients in an area where the motion is rare or very slow. However, with skip mode, since the block size is restricted to 16×16 and the corresponding area is very large, it is only possible to apply skip mode when the whole macro block is within the area; therefore, its effect is limited. Also, skip mode cannot be used by a macro block divided into 16×16 units regardless of the motion of the actual picture. In this case, it is difficult to reduce the amount of bit generation.

### SUMMARY OF THE INVENTION

While motion estimation plays an important role in the performance of motion picture compression, it needs an algorithm capable of reducing the amount of calculation needed for motion estimation in order to perform real-time motion picture encoding.

It is an object of the present invention to provide a method and apparatus for motion estimation, wherein, in a method for compressing a motion picture, a bit generation rate is dramatically reduced by performing motion estimation and compensation at an arbitrary position and in a block unit of an arbitrary size.

Accordingly, a method consistent with the present invention provides for picture compression using a variable block of an arbitrary size, the method comprising: a first step of calculating motion vectors of desired variable blocks; a second step of dividing a screen into a plurality of blocks of arbitrary sizes according to the calculated motion vectors of the variable blocks; and a third step of determining motion vectors with respect to each of the plurality of blocks of the arbitrary sizes constructing the divided screen.

Another method consistent with the present invention provides for picture compression using a variable block of an arbitrary size, the method comprising: a first step of compensating motion with respect to blocks of arbitrary sizes from which motion vectors are decided; and a second step of transmitting block information of an arbitrary size for which the motion is compensated, in order, from a block placed on the upper left of the screen to a block placed on the lower right of the screen.

An apparatus consistent with the present invention provides for picture compression using a variable block of an arbitrary size, comprising: motion vector calculation unit that calculates motion vectors of desired variable blocks; screen dividing unit that divides a screen into a plurality of blocks of arbitrary sizes according to the motion vectors calculated by the motion vector calculation unit; and motion vector determining unit that determines the motion vectors with respect to each of the plurality of blocks of the arbitrary sizes constructing the screen divided by the screen dividing unit.

Preferably, but not necessarily, the apparatus further comprises motion compensation unit compensating motion with respect to the blocks of the arbitrary sizes from which the motion vectors are decided by the motion vector determining unit; and transmission unit that transmits block information of the arbitrary size for which the motion is compensated by the motion compensation unit, in order, from a block placed on the upper left of the screen to a block placed on the lower right of the screen.

### BRIEF DESCRIPTION OF THE DRAWINGS

The above and other features and advantages of the present invention will be readily apparent to those of ordinary skill in the art by the following description of exemplary embodiments with reference to the accompanying drawings, in which:

FIG. 1A is a block diagram showing a coding function of a H.264 motion compressing apparatus;

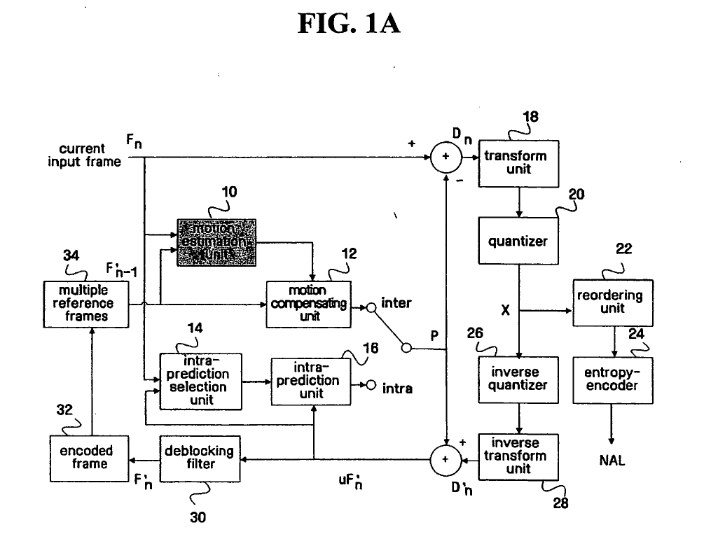

FIG. 1B is a block diagram showing a decoding function of a H.264 motion picture compression apparatus;

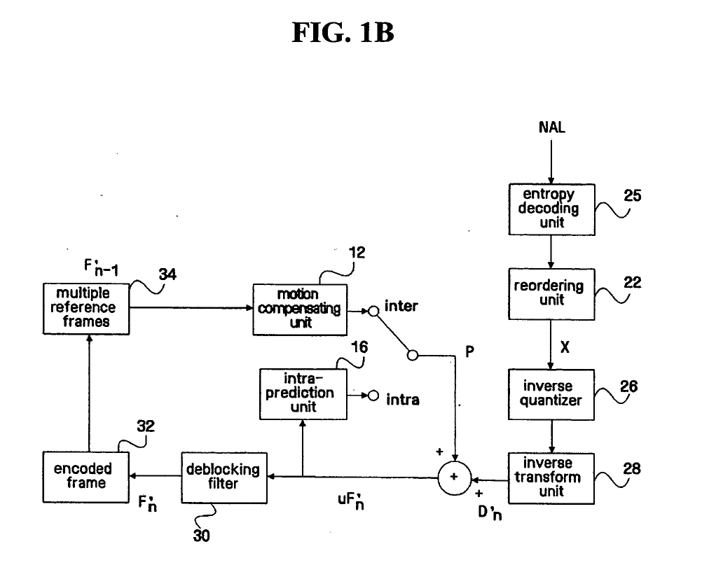

FIG. 2A is a view showing a block size in accordance with a mode of a variable block of a H.264 hierarchy structure;

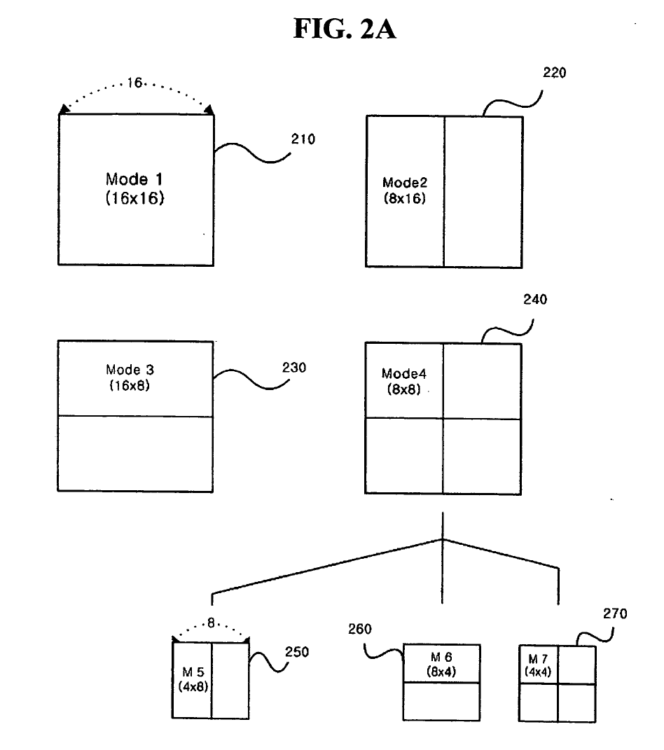

FIG. 2B shows an example arrangement of various modes of a H.264 hierarchy structure;

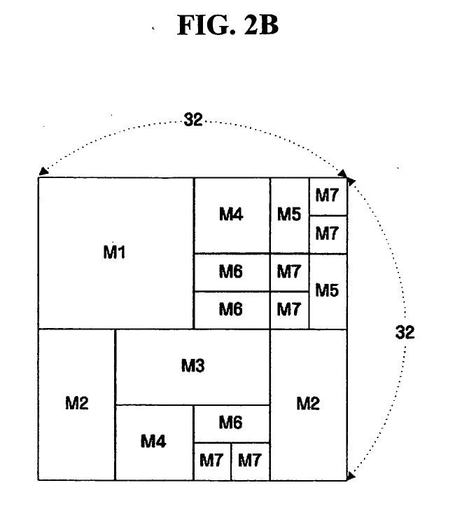

FIG. 3 is a block diagram showing a picture compression apparatus in accordance with an embodiment of the present invention;

FIG. 4 is a flow chart showing a picture compression method in accordance with an embodiment of the present invention;

FIG. 5, which is an example view showing a process for dividing a screen into variable blocks of arbitrary sizes in accordance with an embodiment of the present invention;

FIG. 6 is a view showing a screen map divided into variable blocks of arbitrary sizes in accordance with an embodiment of the present invention; and

FIG. 7 is a view showing a transmission order of information of a variable block of an arbitrary size constructing a screen in accordance with an embodiment of the present invention.

### DETAILED DESCRIPTION OF ILLUSTRATIVE, NON-LIMITING EMBODIMENTS OF THE INVENTION

The present invention will now be described more fully hereinafter with reference to the accompanying drawings, in which illustrative, non-limiting embodiments of the invention are shown. This invention may, however, be embodied in different forms and should not be construed as limited to the embodiments set forth herein. Rather, these exemplary embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

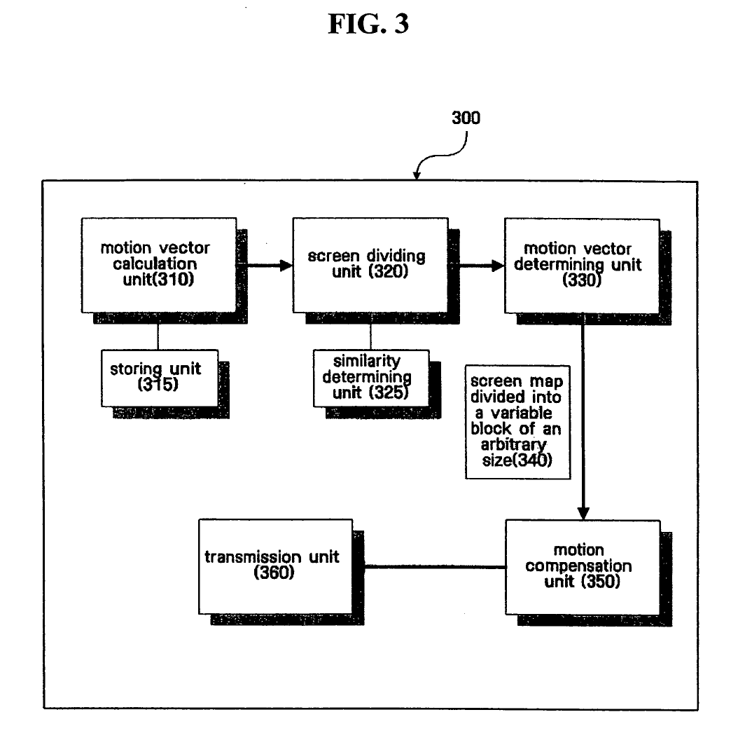

FIG. 3 is a block diagram showing a picture compression apparatus in accordance with an embodiment of the present invention. The picture compression apparatus includes motion vector calculation unit 310 that calculates the motion vectors of desired variable blocks, screen dividing unit 320 for dividing the screen into a plurality of blocks of arbitrary sizes according to a motion vector calculated by the motion vector calculation unit 310, motion vector determining unit 330 that determines the motion vectors with respect to the blocks of the arbitrary sizes constructing the screen divided by the screen dividing unit 320, motion compensation unit 350 that compensates motion with respect to the blocks of the arbitrary sizes from which the motion vectors are determined by the motion vector determining unit 330, and transmission unit 360 that transmits block information of an arbitrary size for which the motion is compensated by the motion compensation unit 350, in order, from a block positioned on the upper left to a block positioned on the lower right of the screen.

The motion vector calculation unit 310 includes storing unit 315, which calculates the motion vectors of minimum unit blocks having the arbitrary size and the costs with respect to bit rate and distortion for the motion vectors and then stores the calculated motion vectors and costs.

The screen dividing unit 320 divides the screen into a plurality of blocks of arbitrary sizes based on the decided arbitrary size and a determination of similarity between motion vectors calculated by the motion vector calculation unit 310. It is desirable, but not necessary, that the arbitrary block size determined by screen dividing unit 320 is limited to less than a desired number. This controls an unlimited increase of information on a block size, which may generated by arbitrarily deciding the block size. The screen dividing unit 320 can divide the screen into blocks of arbitrary sizes disposed in an arbitrary position on the screen.

The screen dividing unit 320 includes similarity determining unit 325 for grouping a plurality of minimum unit blocks disposed in an arbitrary position based on the similarity of the motion vectors among the minimum unit blocks. The similarity determining unit 325 will also determine a similarity of the motion vectors between the grouped block, which is now a block unit, and other adjacent block units, when the motion vectors are mutually similar according to the result of the previous similarity determination.

It is desirable that the motion vector determining unit 330 determines the motion vectors of the blocks of the arbitrary sizes decided by the screen dividing unit 320 using the motion vectors of smaller blocks constructing the variable blocks.

A map, which divides the screen into blocks of arbitrary sizes in the fashion described above, is screen map 340, which is divided into a variable block of an arbitrary size shown in FIG. 3.

The motion compensation unit 350 performs motion compensation with respect to the blocks of the arbitrary sizes from which the motion vectors are determined by the motion vector determining unit 330, and the transmitting unit 360 transmits block information of the arbitrary size to which the motion compensation was performed by the motion compensation unit 350, in order, from a block disposed on the upper left of the screen to a block disposed on the lower right of the screen.

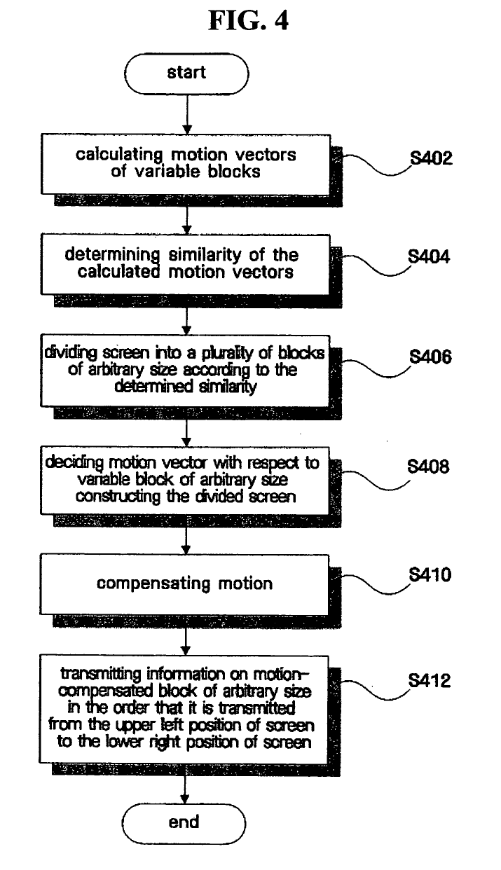

FIG. 4 is a flow chart showing a picture compression method in accordance with an embodiment of the present invention. The motion vector calculation unit 310 calculates motion vectors of desired variable blocks (S402). Preferably, but not necessarily, after the motion vectors of the minimum unit blocks having arbitrary sizes and costs for the motion vectors are calculated, the calculated motion vector and costs are stored in the storing unit 315.

Then, a determination process for comparing whether the motion vectors of the calculated minimum unit blocks are similar is performed (S404). That is, the block size is decided in an arbitrary position and in an arbitrary size according to the determination result, and the similarity determination is performed between the minimum unit blocks constructing the grouped blocks after a plurality of minimum unit blocks are grouped in an arbitrary position. Using the similarity determination results, the similarity determining unit 325 performs grouping of similar blocks, with respect to the motion vectors, by combining them, and a similarity of the motion vectors between the combined block unit and other adjacent block units is determined again. For example, although there are many similarity determination methods, in one case, if a vector difference of the motion vectors of adjacent blocks which are subjects for comparison is less than or equal to a desired threshold, it would mean that there is little change in motion, thus, the motion vectors are determined as being similar.

In the next step, the screen dividing unit 320 divides the screen into a plurality of blocks of arbitrary sizes according to the determined similarity result (S406). Since, within limits, the block sizes are arbitrarily decided, it is possible to divide the screen positions arbitrarily.

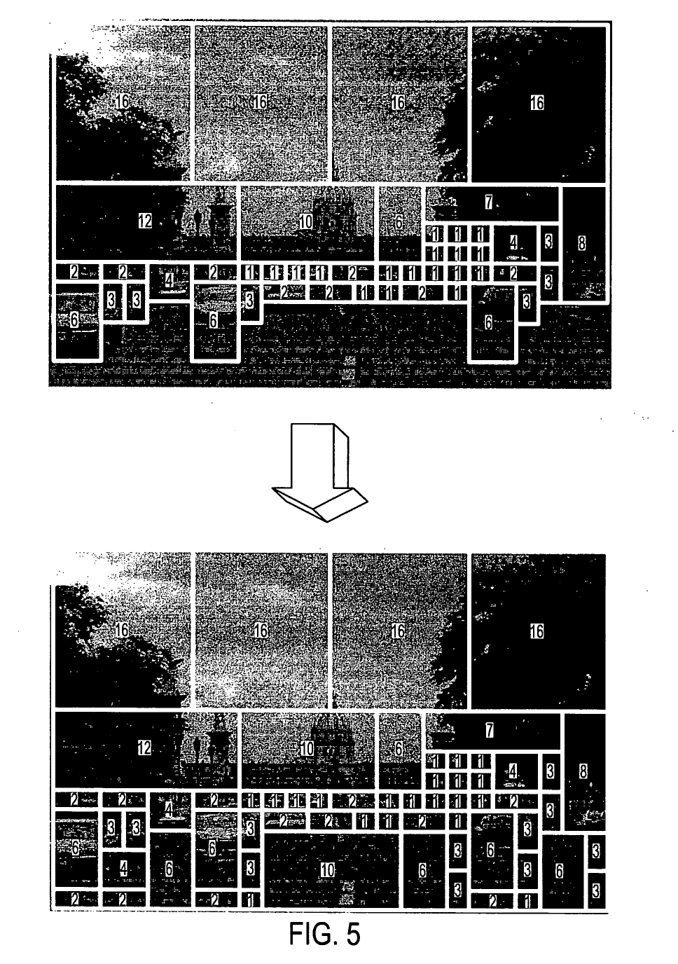

When the motion vectors between two blocks are determined to be similar, the two blocks are grouped and the motion vectors of the grouped block and other adjacent blocks are compared for similarity. When these motion vectors are determined to be similar, these blocks are grouped again, and when the motion vectors are determined not to be similar, the motion vectors of the grouped block and another adjacent block are compared for similarity. When the motion vectors between adjacent blocks are not similar, the block size is fixed as is. An example of a view showing the process for dividing a screen into variable blocks of arbitrary sizes in accordance with an embodiment of the present invention is illustrated in FIG. 5.

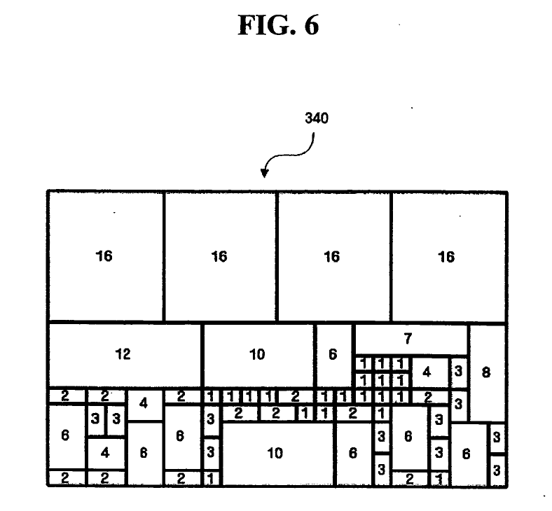

Reviewing the upper picture of FIG. 5, the results of comparing the motion vectors between the variable blocks in an arbitrary position produced block sizes that are relatively large since the sky, the clouds, the front building and the big trees on the sides of the picture have little motion. However, since cars go at a high speed, the portions where the cars are traveling on the road is divided into relatively small blocks. The minimum unit block size can be arbitrarily decided by a user and need not be a 4×4 size as defined by the H.264 standard. In FIG. 5, block 1 is established as a variable block of the minimum unit in the picture. If the motion vectors of two horizontal block 1s are mutually similar, then they are combined to become block 2. If a block 1 is joined to another block 1 vertically, they become block 3. If a block 3 is joined to another block 3 in the left or right direction, they become block 4. However, the rule regulating the block sizes does not necessarily have to follow the above exemplary rule, and the user can decide it arbitrarily. The lower picture of FIG. 5 shows the results of the block division. The block size is limited to a desired number or less, this is because information with respect to each block increases with the size and may become too much. The block size is limited to 16 in the exemplary embodiment of the present invention. FIG. 6 illustrates the screen map 340 which is divided into the variable blocks of the arbitrary sizes as a result of using the above method.

In the next step, the motion vector determining unit 330 determines a motion vector with respect to the variable block of an arbitrary size constructing the divided screen (S408). It is desirable, but not necessary, that the motion vector determining unit 330 determines the motion vector of the block, whose size was decided in the screen-dividing step, using the motion vectors of the smaller blocks constructing the grouped variable block. Especially, it is desirable, but not necessary, to make a decision using an intermediate value among the motion vectors of the smaller hierarchy blocks constructing the grouped variable block.

When an average value is subtracted from each of the motion vectors of the smaller blocks constructing the grouped higher block, as many difference signals as the number of smaller blocks constructing the group will remain. However, since a block of the intermediate value among a plurality of smaller blocks constructing a group has a difference signal of 0, this block has no difference signal, and the remaining blocks have a large difference signal relatively. The second scheme is known to generate fewer bits experimentally and statistically when the compression is performed by transformation in a transform unit.

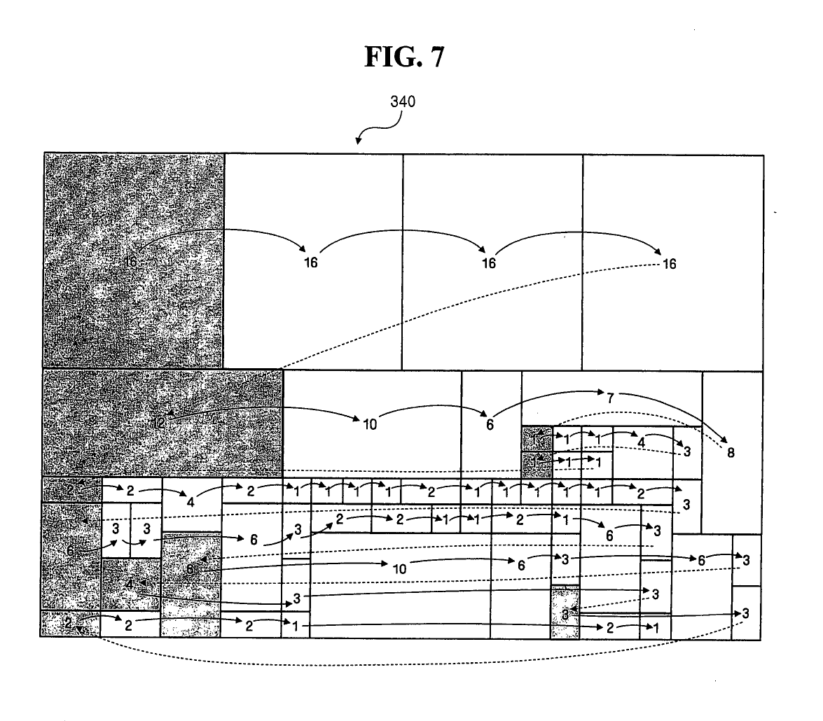

In the next step, the motion compensation unit 350 performs motion compensation of the previous frame with respect to the block of the arbitrary size from which the motion vector is decided and forms a predicted image (S410). Then, the transmitting unit 360 transmits block information of an arbitrary size whose motion has been compensated by the motion compensation unit 350 to a decoder in order to decode it, wherein the block information to be transmitted includes the order information of the blocks of the arbitrary sizes. As an example of an order for transmitting the block information, the step of transmitting the block information follows an order such that the block information is transmitted from the upper left position of the screen to the lower right position of the screen (S412). This process is shown in FIG. 7, which is a view showing a transmission order of a variable block of an arbitrary size constructing a screen in accordance with an embodiment of the present invention.

Referring to FIG. 7, the block information is transmitted starting from a block 16, which is located on the upper left of the screen, and the block information to the right is transmitted next. When the information of the right most block is transmitted, the transmitting process proceeds to left block 12 followed by block 10, block 6, block 7, and block 8. Generally, a block disposed in the left-most highest part of the screen among the remaining blocks is selected to be transmitted. By uniformly defining the order of transmitting the block information, it is not necessary to separately transmit the information on the block position.

The transmission order can be applied to transmitting variable blocks of an arbitrary size to the transform unit 18 as well as transmitting to the decoder.

After the variable blocks of the arbitrary size have been transmitted to the decoder in order, the decoding of the variable blocks will follow using the same order.

A video compression algorithm using a method of estimating motion of a hierarchy structure has problems, which increase in proportion to the number of levels in the hierarchy structure due to the redundant nature of the hierarchy structure. The present invention reduces the bit generation rate with respect to a motion coefficient and the problems of calculation in motion estimation for performing motion estimation with respect to time in picture compression, and the compression efficiency is enhanced by making block sizes different according to the specific properties of the pictures.

Also, the bit generation rate can be reduced since the transmission order of block information of an arbitrary size is fixed.

Although the exemplary embodiments and drawings of the present invention have been disclosed for illustrative purposes, those skilled in the art appreciate that various substitutions, modifications, changes and additions are possible, without departing from the scope and spirit of the invention as disclosed in the accompanying claims.

1. A method for picture compression using a variable block of an arbitrary size, the method comprising:
a first step of calculating motion vectors of variable blocks;
a second step of dividing a screen into a plurality of blocks of arbitrary sizes according to the calculated motion vectors of the variable blocks; and
a third step of determining motion vectors with respect to each of the plurality of blocks of the arbitrary sizes constructing the divided screen.

2. The method according to claim 1, wherein the first step includes;
a first process of calculating the motion vectors of the variable blocks using minimum unit blocks of arbitrary sizes and calculating costs with respect to bit rate and distortion for the motion vectors of the variable blocks; and
a second process of storing the calculated motion vectors and the calculated costs.

3. The method according to claim 1, wherein the second step is a step of determining block sizes based on similarity between the calculated motion vectors of the variable blocks, and dividing the screen into a plurality of blocks having the determined sizes.

4. The method according to claim 3, wherein the determined block sizes are less than a predetermined value.

5. The method according to claim 3, wherein the similarity determination includes grouping a plurality of minimum unit blocks into a grouped block disposed in an arbitrary position, and
wherein the similarity determination is performed between the minimum unit blocks constructing the grouped block.

6. The method according to claim 5, comprising:
determining a similarity between motion vectors of the grouped block and other adjacent block units when the motion vectors are determined to be similar in a previous similarity determination.

7. The method according to claim 3, wherein each block dividing the screen is disposed in an arbitrary position on the screen.

8. The method according to claim 1, wherein the third step is a step of determining the motion vectors of the blocks of the arbitrary sizes formed in the second step using motion vectors of smaller blocks constructing the variable blocks.

9. A method for picture compression using a variable block of an arbitrary size, the method comprising:
a first step of compensating motion with respect to a block of an arbitrary size from which motion vectors are determined; and
a second step of transmitting block information of the block of an arbitrary size for which the motion is compensated, in order, from a block disposed on the upper left of a screen to a block disposed on the lower right of the screen.

10. The method according to claim 9, further comprising:
a third step of decoding the transmitted block information, in order, from the block disposed in the upper left of the screen to the block disposed in the lower right of the screen.

11. An apparatus for picture compression using a variable block of an arbitrary size, comprising:
a motion vector calculation unit that calculates motion vectors of variable blocks;
a screen dividing unit that divides a screen into a plurality of blocks of arbitrary sizes according to the motion vectors calculated by the motion vector calculation unit; and
a motion vector determining unit that determines motion vectors with respect to each of the plurality of blocks of the arbitrary sizes constructing the screen divided by the screen dividing unit.

12. The apparatus according to claim 11, wherein, after calculating the motion vectors of the variable blocks using minimum unit blocks of arbitrary sizes and calculating costs with respect to bit rate and distortion for the motion vectors of the variable blocks, the motion vector calculation unit includes a storing unit that stores the calculated motion vectors and the calculated costs.

13. The apparatus according to claim 11, wherein the screen dividing unit divides the screen into a plurality of blocks of a determined size by determining a block size based on similarity between the motion vectors of the variable blocks calculated by the motion vector calculation unit.

14. The apparatus according to claim 12, wherein the screen dividing unit divides the screen into a plurality of blocks of a determined size by determining a block size based on similarity between the motion vectors of the variable blocks calculated by the motion vector calculation unit.

15. The apparatus according to claim 13, wherein the determined block size is less than a predetermined value.

16. The apparatus according to claim 14, wherein the determined block size is less than a predetermined value.

17. The apparatus according to claim 13, wherein the screen dividing unit includes a similarity determining unit for grouping a plurality of minimum unit blocks into a grouped block disposed in an arbitrary position and determining a similarity of the motion vectors between the minimum unit blocks constructing the grouped block.

18. The apparatus according to claim 14, wherein the screen dividing unit includes a similarity determining unit for grouping a plurality of minimum unit blocks into a grouped block disposed in an arbitrary position and determining a similarity of the motion vectors between the minimum unit blocks constructing the grouped block.

19. The apparatus according to claim 17, wherein the similarity determining unit determines a similarity of the motion vectors between the grouped block and other adjacent block units, when the motion vectors are determined to be similar in a previous similarity determination.

20. The apparatus according to claim 18, wherein the similarity determining unit determines a similarity of the motion vectors between the grouped block and other adjacent block units, when the motion vectors are determined to be similar in a previous similarity determination.

21. The apparatus according to claim 13, wherein each block dividing the screen is disposed in an arbitrary position on the screen.

22. The apparatus according to claim 14, wherein each block dividing the screen is disposed in an arbitrary position on the screen.

23. The apparatus according to claim 11, wherein the motion vector determining unit determines the motion vectors of the blocks of the arbitrary sizes using motion vectors of smaller blocks constructing the variable blocks.

24. The apparatus according to claim 11, further comprising:
a motion compensation unit compensating motion with respect to the blocks of the arbitrary sizes from which the motion vectors are decided by the motion vector determining unit; and
a transmission unit that transmits block information of the block of an arbitrary size for which the motion is compensated by the motion compensation unit, in order, from a block disposed on the upper left of the screen to a block disposed on the lower right of the screen.
